(19) United States
(12) Patent Application Publication
(10) Pub. No.: US 2002/0167585 A1
(43) Pub. Date: Nov. 14, 2002

(54) Multibeam multi-wavelength internal drum recording apparatus

(76) Inventors: Dov Berman, Hofit (IL); Serge Steinblatt, Raanana (IL); Nissim Pilossof, Rehovot (IL)

Correspondence Address: DARBY & DARBY P.C., POST OFFICE BOX 5257, NEW YORK, NY, 10150-5257, US

(21) Appl. No.: 10/001,890

(22) Filed: Nov. 16, 2001

Related U.S. Application Data
(63) Continuation-in-part of application No. PCT/IL00/00317, filed on Jun. 1, 2000.
(63) Continuation-in-part of application No. 09/693,622, filed on Oct. 20, 2000.

(30) Foreign Application Priority Data
Jun. 7, 1999 (IL) 130340

(51) Int. Cl. B41J 15/14

(52) U.S. Cl. 347/241

(57) ABSTRACT

Internal drum recording apparatus provided with a rotating deflecting element, comprising two (or more) beams of different wavelenghts, which are simultaneously operatable, and optical elements for bringing the two or more beams to a common optical path before they reach the rotating deflecting element. The deflecting element may have dispersing properties such that beams of different wavelengths will leave it at slightly different angles. The beams of different wavelengths may be generated by laser diodes or tunable laser diodes. The apparatus may further comprise a beam combiner to combine the beams generated by the light sources.

### CROSS-REFERENCE TO PREVIOUS APPLICATIONS

This application is a continuation-in-part based on PCT application no. PCT/IL00/00317 filed Jun. 1, 2000, and corresponding to U.S. patent application Ser. No. 09/693,622 filed Jun. 1, 2000.

### FIELD OF THE INVENTION

The present invention relates to internal drum recording apparatus. More particularly, the invention relates to apparatus for recording an image on a photosensitive recording medium, and to a method for carrying out the recording with high throughput.

### BACKGROUND OF THE INVENTION

Drum image-setters, generally speaking, comprise a drum on which a photosensitive recording medium is positioned, and beam generating means for generating a beam which is capable of recording an image on the medium. The recorded medium is then used in the printing process of the images previously recorded. In external drum image-setters the photosensitive medium is positioned in the outer surface of the drum. In contrast, in internal drum image-setters, with which the present invention is concerned, the medium is positioned on the internal surface of the drum.

FIG. 1 schematically illustrates a classical configuration of an internal drum recording apparatus. It includes mainly the drum 1 that supports the recording material 2, a guide beam 3 on which a carriage 4 is moving. The carriage 4 supports a deflecting rotating element 5, shown as a cube reflector in the figure, although other elements, such as a penta prism or a mirror, are also possible. It also supports a focusing lens 6. The light source assembly 7 is attached to the drum 1 or to guide beam 3, and emits a collimate beam 8 in the direction of the carriage 4.

It is well known that the direction of the collimated beam determines to what extent the imaged line will be a straight line.

When attempting to operate a multibeam internal drum scanner, two beams which are meant to record two lines, when in close proximity, originated by two non-parallel collimated beams will intersect if the non-parallelism is too high. This problem is schematically shown in FIG. 2, where the two beams from the source are indicated by 8 and 8′, and the resulting beams writing on the photosensitive material, as 9 and 9′, which image lines 100 and 100′. In any case, the slightest departure from parallelism in the collimated beams will result in non-parallel imaged lines.

Internal drum image-setters which work with a single imaging beam, tend to be limited in throughput because of mechanical limitations. As the available data rate increases with the increased performances of the screen processors, the only way to take advantage of this situation, when using a single imaging beam in an internal drum configuration, is to increase the rotation speed of the rotating deflecting element that directs the light towards the light sensitive material. Increasing the rotation speed, however, is also limited by the technology available in the art.

Various schemes of internal drum image-setters, operating with more than one simultaneously recording beam, have been reported. Some are based on the use of a rotating element that is equivalent to mirror parallel to the rotation axis (U.S. Pat. No. 5,579,115). Others use a derotation element which spins in synchronization of the deflecting element, at half the speed, as described in U.S. Pat. No. 5,214,528. Others use two beams of different polarization (EP 483827). Another attempt to solve the problem is described in U.S. Pat. No. 5,764,381, in which the light sources inside the drum rotate.

PCT applications WO 91/08504 and WO 97/42596 also address the same problem, as does the book “Spectralnie Pribory” (“Spectral Devices”) written in Russian by K. I. Tarasov, Leningrad, pp. 170-171.

All the attempts made in the prior art to solve this problem of internal drum recording apparatus have significant drawbacks. They generally involve complex solutions, and have limitations. For instance, providing a mirror parallel to the drum axis results in apparatus that is limited in scanning angle. Apparatus based on derotation requires extremely accurate and stable mechanical adjustments. Apparatus using double polarization is limited to two beams. Apparatus using rotating sources requires data transfer to the rotating sources, which is complicated and expensive.

Thus, the art has so far failed to provide a simple and efficient solution to the aforementioned problems.

It is therefore an object of the invention to provide apparatus which overcomes the aforementioned disadvantages of the prior art, and which permits to provide high throughputs of internal drum imaging apparatus.

It is another object of the invention to provide apparatus based on the traditional internal drum scheme.

It is a further object of the invention to provide apparatus which, with minor modifications to an existing system, allows updating from single to multibeam operation.

It is yet another object of the invention to provide a method for operating a plurality of beams in an internal drum imaging apparatus.

Other objects and advantages of the invention will become apparent as the description proceeds.

### SUMMARY OF THE INVENTION

The invention is directed to internal drum recording apparatus provided with a rotating deflecting element, comprising two or more beams of different wavelength, said two or more beams being simultaneously operable, and optical elements for bringing said two or more beams to a common optical path before they reach said rotating deflecting element.

According to a preferred embodiment of the invention the deflecting element has dispersing properties such that beams of different wavelengths will leave it at slightly different angles.

In a preferred embodiment of the invention the beams of different wavelengths are generated by laser diodes. Preferably—but non limitatively—the laser diodes are tunable laser diodes.

The apparatus of the invention comprises a beam combiner to combine the beams generated by the light sources. According to a preferred embodiment of the invention the beam combiner is a beam splitter. According to another preferred embodiment of the invention the beam combiner is a dichroic beam combiner. According to still another preferred embodiment of the invention the beam combiner comprises an optical fiber coupler.

In another aspect the invention is directed to a dispersing prism for use as a deflecting element in a multi-beam, multi-wavelength internal drum recording apparatus, comprising two coupled transparent optical elements between which a reflective surface is provided, said reflective surface being inclined at about 45 degrees with respect to the input beam, and wherein the input and/or output face(s) of the prism are tilted with respect to the optical axis.

According to a preferred embodiment of the invention there is provided a dispersing prism for use as a deflecting element in a multi-beam, multi-wavelength internal drum recording apparatus, comprising two coupled transparent optical elements between which a reflective surface is provided, said reflective surface being inclined at about 45 degrees with respect to the input beam, and wherein the input or output face of the prism has a cylindrical shape.

The invention also encompasses a prism assembly, comprising a prism the input face of which has a cylindrical shape, which is coupled to a lens having a refractive index different from that of the dispersing prism. Alternatively, the prism can be coupled to to a wedged prism. Illustrative and non-limitative examples of suitable lenses include cylindrical lens and wedge cylindrical lens.

The invention further provides a method for separating the imaged lines in a multi-beam, multi-wavelength internal drum recording apparatus, by tuning the source wavelength, said method comprising the steps of providing, for each desired resolution, a mask consisting of a reflective layer deposited on a transparent surface from which said reflective layer has been removed so as to form two parallel line segments positioned one after the other with an offset, the width of said lines being small compared to the optical spot size used, positioning behind the mask a light detector capable of detecting peak signals, and tuning independently at least one of the light sources so as to obtain the maximum peak signal.

The invention further conveniently provides a method for operating with high throughput an internal drum recording apparatus provided with a rotating deflecting element, comprising providing two or more simultaneously operable beams of different wavelength, and bringing said two or more beams to a common optical path before they reach said rotating deflecting element.

According to a preferred embodiment of the invention the deflecting element has dispersing properties such that beams of different wavelengths will leave it a slightly different angles.

### BRIEF DESCRIPTIONS OF THE DRAWINGS

In the drawings:

FIG. 1 is a schematic illustration of a prior art internal drum recording apparatus;

FIG. 2 is a schematic illustration of an internal drum configuration operating with two beams and generating intersecting lines;

FIG. 3 shows a beam combining optics, based on bulk optical elements;

FIG. 4 shows a beam combining optics, based on optical fiber elements;

FIG. 5 is a layout of an optical system showing the dispersing scheme, according to a preferred embodiment of the invention;

FIG. 6 (A through D) shows the details of two dispersing prism constructions and two prism assemblies, according to various preferred embodiments of the invention;

FIG. 7 schematically shows the internal drum in a configuration according to a preferred embodiment of the invention;

FIG. 8A illustrates an alignment mask assembly;

FIG. 8B shows the alignment obtained by the alignment mask assembly of FIG. 8A;

FIG. 9 is a flow chart of the wavelength tuning procedure according to a preferred embodiment of the invention;

FIG. 10 is a block diagram of a system according to one embodiment of the invention;

FIG. 11 schematically illustrates a system according to one embodiment of the invention, in which the reflective surface of the deflecting element is separated from the dispersing element;

FIG. 12 schematically illustrates the operation of the deflecting element, according to one embodiment of the invention; and

FIGS. 13a to 13c and FIG. 14 schematically illustrate a system according to one embodiment of the invention, in which the OPD value is improved by adding two additional lenses.

### DETAILED DESCRIPTION OF THE INVENTION

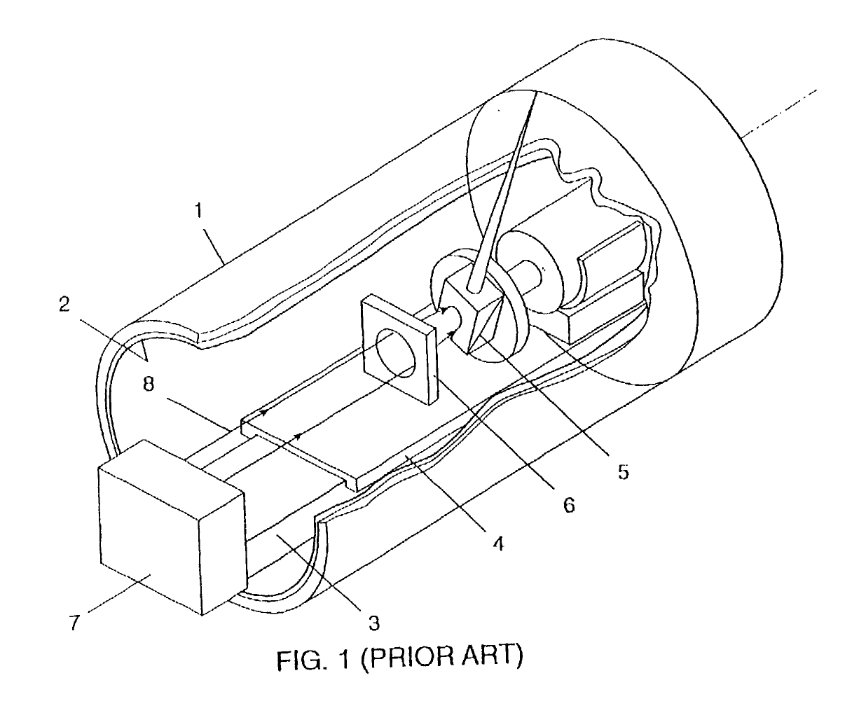

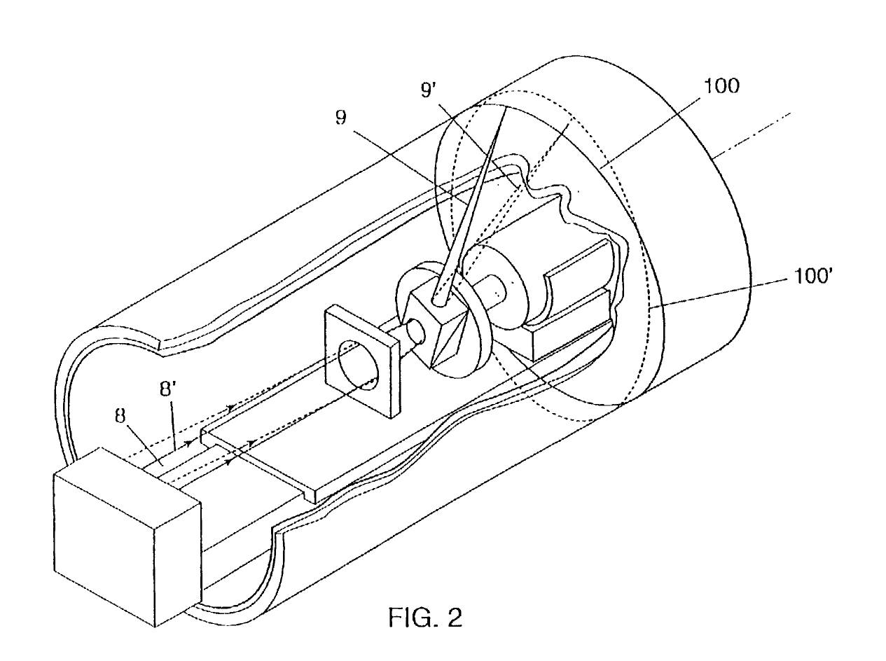

The invention will now be described with reference to illustrative and non-limitative preferred embodiments thereof. Multiple sources operating at different wavelengths are used to produce a combined beam that is fed to the rotating deflecting element (5 of FIG. 1). The center wavelengths of the sources will be designated by λ₁, λ₂, . . . λₙ. In the following description, however, reference will be made to two sources only, for the sake of simplicity,

although, as will be apparent to the skilled person, the invention is by no means limited to two sources only, and a plurality of sources can be provided, compatibly with space and cost considerations.

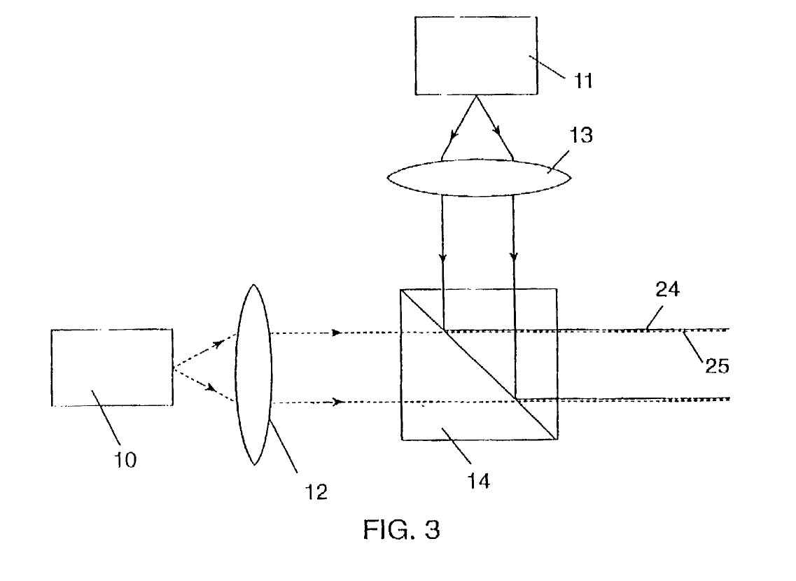

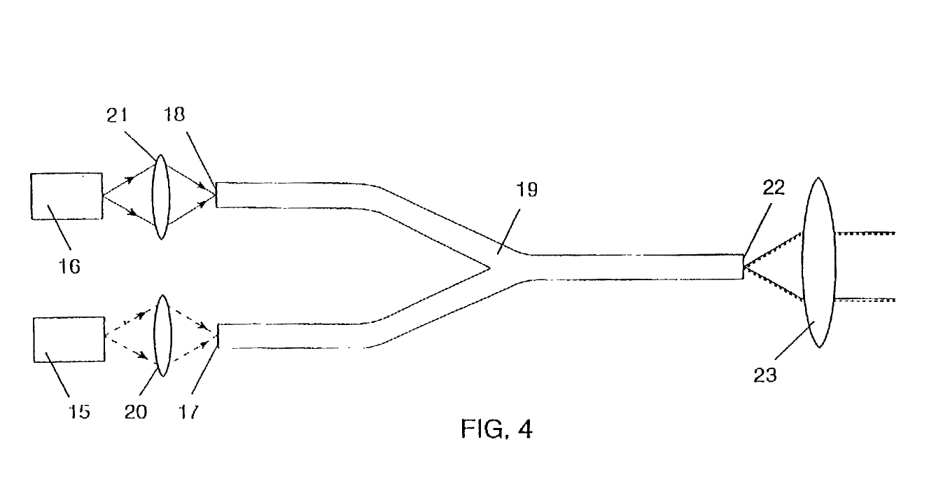

FIGS. 3 and 4 schematically illustrate the method for obtaining the superposition of the multi-wavelength beams, according to preferred embodiments of the invention.

In one method bulk optical elements are used, as shown in FIG. 3. Two laser sources, indicated by numerals 10 and 11, are used. These two sources have different wavelengths, as explained hereinbefore. The light emitted by these sources is collimated using the collimation lenses 12 and 13, respectively, and are then fed into a beam combiner 14, to yield the combined beams 24 and 25 parallel to each other. This beam combiner can be, e.g., a 50%/50% beam splitter, in which case 50% of the light power of both beam will be lost. A dichroic beam combiner can also be used, in the case the wavelengths are different enough to be resolved by a dichroic coating. In such case, more than 80% of the power of each source will reach the combined beam.

A preferred (but by no means only) way of producing a combined beam is to use optical fiber components, as shown in FIG. 4. The light emitted at different wavelengths by the light sources 15 and 16 is coupled into the input ends 17 and 18 of an optical fiber coupler 19, through coupling lenses 20 and 21. As before, if a standard fiber optics 50%/50% coupler is used, 50% of the light power will be lost at the output end 22 of the coupler. But if a WDM (Wavelength Division Multiplexer) coupler is used, more than 80% of the power of each beam coupled into the input ends of the coupler will reach the output end.

The configuration of FIG. 4 is preferred, because at the output of the coupler the beams are perfectly superposed. As a result of this fact, the collimation lens 23 will form two collimated beams that are perfectly parallel. In the case of FIG. 3, mechanical misalignment can occur over time, and beams 24 and 25 will not stay parallel to each other.

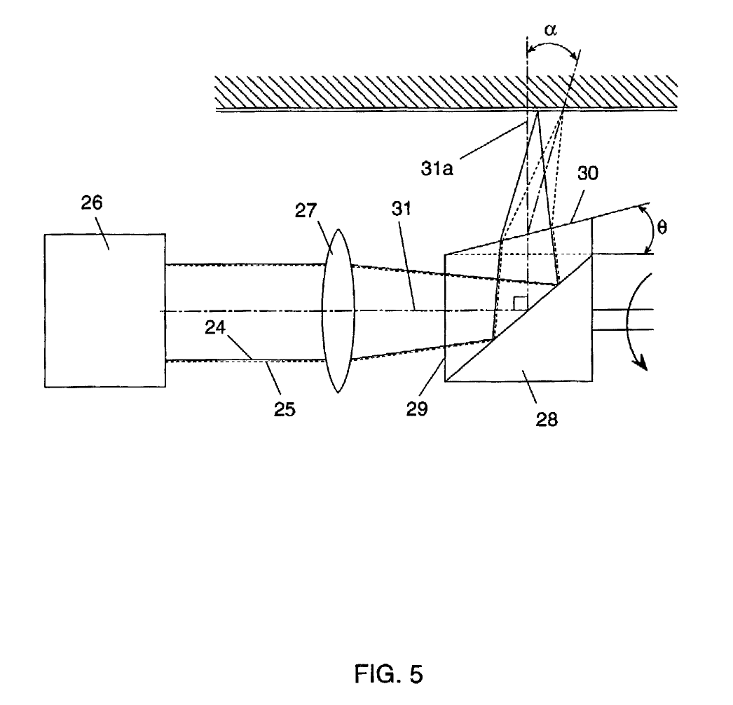

FIG. 5 schematically shows how the beams are separated by the deflecting rotating element. The collimated beams 24 and 25 are emitted by the light source assembly 26, which is built as explained above. The light is then focused by a focusing lens 27 which, according to this preferred embodiment of the invention, is positioned before the rotating deflecting element 28. In another preferred embodiment of the invention, the focusing lens 27 can be positioned after the deflecting element 28, and rotate with it.

The deflecting element 28, according to a preferred embodiment of the invention, is built of a dispersing prism. Its input facet 29 is substantially perpendicular to the axis 31 of the beam leaving the focusing lens 27, while the output facet 30 is at an angle θ with respect to said axis. The dispersion of the beams takes place on the boundary air-surface 30 and depending on the wavelength the beams will further travel at different angles α with respect to the axis 31a. The angular difference will be a direct consequence of Snell's law:

Δα−arc sin(λ1)*sin(θ))−arc sin(n(λ2)*sin(θ))

where λ1 and α2 are the wave lengths of the beams 24 and 25 respectively, and n(λ1) and n(λ2) are the dispersion coefficients of the glass for the said wavelengths λ1 and λ2 respectively. From consideration for symmetry of the rotating prism, it is obvious that the designer's goal will be to obtain high dispersion while maintaining a low angle θ. This can be achieved by using high-dispersion glass, such as SCHOTT's FK51. In this case, assuming that λ1=645 nm, λ2=655 nm and θ=12.1 deg., the angular difference will be Δα=5×10⁻⁵ rad (2.867×10⁻³ deg.). At 200 mm drum radius, such angular displacement will result in approximately 10 μm position displacement of the two beams.

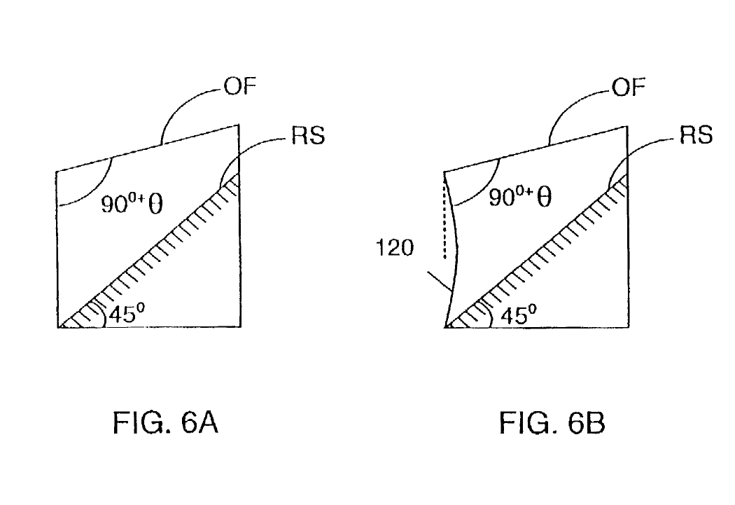

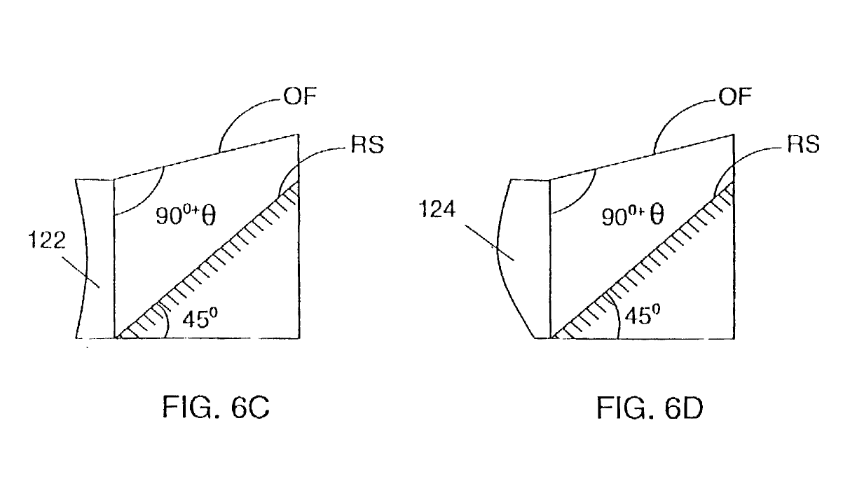

FIG. 6A illustrates details of the construction of the dispersing prism according to a particular preferred embodiment of the invention. This prism is basically a cube reflector, in which the output facet OF is tilted with respect to the optical axis. The deflector is built of glass, in two parts, between which a reflective surface RS has been deposited. This surface is inclined at 45 degrees, with respect to the input beam. The output beam will meet the output facet, which is at an angle of 90+θ degrees with respect to the optical axis. This angle θ is chosen so as to achieve the required spot separation in the image plane, as a function of the wavelength difference between the sources, the dispersion properties of the glass used to manufacture the rotating prism, and the radius of the drum. Additionally, the input or output faces, or both, could be tilted.

The prism can be made in various manners, which will be apparent to the skilled person. In order to illustrate the construction of the cylindrical face prism, and the resulting assembly, the following parameters can be used: Material of the prism: Schott glass F2; Angle θ=15°; Center wavelength separation of the diodes: 4 nm; Tuning range of the diodes: ±2 nm; Drum internal diameter: 400 mm. Under these conditions, line spacings between 6 and 16 microns can be achieved, corresponding respectively to imaging resolutions from 140 to 60 lines per mm.

In some cases, depending on the convergence of the beam entering the dispensing prism, the optical aberrations produced by the dispersing prism may not be compatible with the required imaging quality. Several ways are used to compensate for this aberration. First, as shown in FIG. 6B, the input face 120 of the dispersing prism is given a cylindrical shape. The optical aberration is further reduced when a cylindrical lens 122 is added the dispersing prism, as shown in FIG. 6C, lens 122 having a refractive index different from the one of the dispersing prism.

The optical aberration is even further reduced when a wedged cylindrical lens 124 (or a wedged cylindrical prism—not shown) is added to the dispersing prism, as shown in FIG. 6D, lens 124 (or the wedged prism) having, again, a refractive index different from the one of the dispersing prism.

The radius of curvature of the cylinder surface depends on the convergence of the light beam and the characteristics of the glasses that are used. The optimal radius that minimizes the aberrations can be determined using conventional optical simulation software.

In all the above examples, the cylinder surfaces are shown on the input face of the deflecting prism. In an equivalent way the cylinder surface can be on the output face side of the deflecting prism.

According to the present invention the angular separation of the beams is produced by the rotating element. As a consequence, and as can be seen in FIG. 7, the separated beams 29 and 30 will image parallel lines, without intersecting. In particular, when optical fibers elements are used, the beams will be in perfect superposition, so that the distance between the two imaged lines will remain constant throughout the rotation of the deflecting element 5.

Normally, it will be necessary to adjust the distance between the separate spots, and consequently the distance between the imaged lines, according to the required imaging resolution. This can be easily done by tuning the wavelengths of the source.

In the same way, the distance between the image lines can be varied according to the various imaging resolutions.

From the practical point of view, tunable laser diode systems can be used as tunable sources, although other sources can also be employed, as will be apparent to the skilled person. Such tunable laser diodes are commercially available, e.g. from SDL (U.S.A.) and New Focus (U.S.A.).

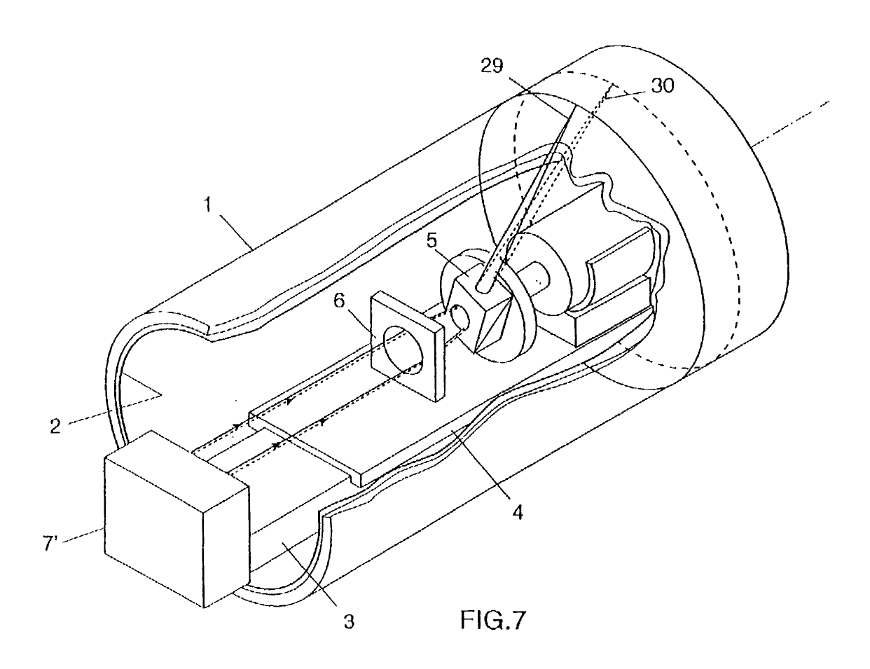

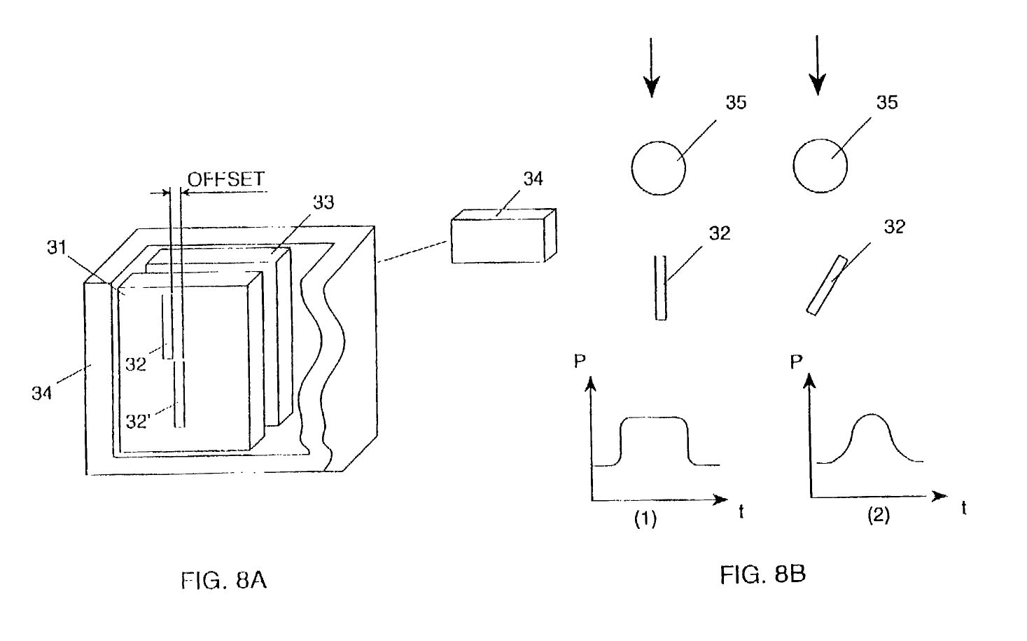

According to a preferred embodiment of the invention an apparatus is used for the adjustment of the separation of the imaged lines, through the tuning of the sources wavelength. Said apparatus is based on a set of light detectors and alignment masks, as shown in FIG. 8A. One such set is required for each resolution. The mask 31 consists of a glass substrate on which a reflective layer has been deposited. The reflective layer is removed over two parallel line segments, 32 and 32′, which are positioned one after the other, but with an OFFSET. These lines have a width that is small compared to the optical spot size used at the specific wavelength. Since the laser spot has a Gaussian distribution, a line width of the order of FWHM (full width, half maximum) of the spot size is acceptable.

The offset of the lines is set at the distance of two adjacent lines at the specific resolution. The mask is produced by photolithographic techniques, which reach sub-micron accuracy. This is adequate, since the resolution of imaging devices of this type is of the order of 100 l/mm, corresponding to a necessary offset of 10 μm.

A light detector, schematically shown in the figure and indicated by numeral 33, is located behind the mask, and its electronics 34 is capable of detecting peak signals. The mask and the detector are mounted in a common housing which can be adjusted in rotation so that the mask rotates in its plane.

This assembly is mounted on the drum (1 of FIG. 7), at a position accessible to the light beams, and so that the mask is in the image plane, i.e. tangent to the drum inner surface.

The method of the invention is very sensitive and can thus be used with relatively small differences in wavelength. Typically, wavelength having a difference, Δλ=4 nm can be employed, an illustrative and non-limitative wavelength being of the order of 633 nm.

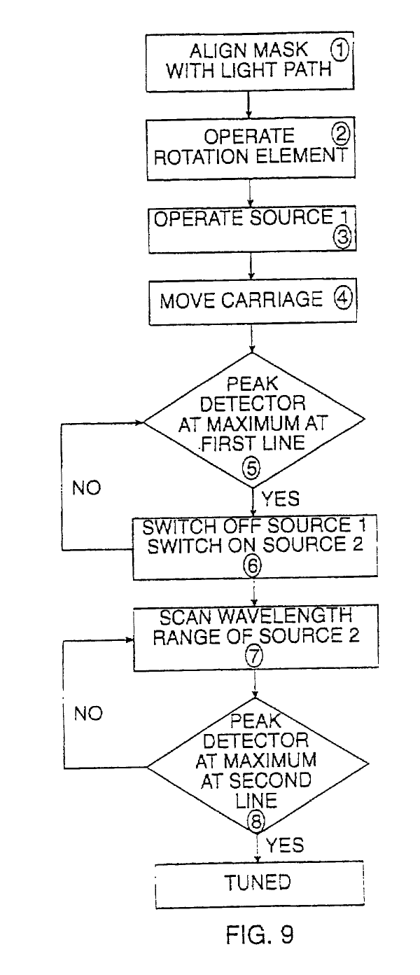

The tuning procedure is performed as follows. As a first step, the mask assembly is aligned with the beam path (Step 1 in the flow chart of FIG. 9). This is done by observing the signal seen by the detector on an oscilloscope, as depicted in FIG. 8b. One of the sources is operated continuously while the rotating element 5 is rotated and the carriage 4 is moved until the light beam crosses line 32, at which time the carriage is stopped. If line 32 is at an angle with respect to the beam path depicted by light spot 35 moving in the direction of the arrow, one sees a signal which is shorter than when alignment is obtained, and has less steep leading and falling edges (signal (2) in FIG. 8B). If line 32 is aligned with the beam path depicted by light spot 35 moving in the direction of the arrow, one sees a quasi-square signal (signal (1) in FIG. 8B). The mask assembly will be adjusted in rotation to obtain the widest signal and the steepest edges. This step is part of the machine calibration, and is done once, at the assembly and final testing of the machine.

The next sequence is used to actively set the distance between the imaged lines, whenever this is necessary. The description of the elements is made with reference to FIG. 7. The rotating element 5 is operated (Step 2, FIG. 9) and the first light source located in combined light source assembly 7′ is operated (Step 3, FIG. 9). The carriage 4 is then operated, while the signal at the detector is monitored. The carriage 4 is moved back and forth in a sequence (Step 4, FIG. 9) so as to detect the maximum peak signal at the detector, on the first mask line 32 of FIG. 8A (Step 5, FIG. 9). As the laser beam has a Gaussian distribution, the maximum peak signal will be observed when the light beam is centered on the first mask line. It is known whether the line passes through line 32 or 32′, e.g. by moving the carriage in a direction coming from the side of line 32, so that the first signal detected corresponds to line 32.

The first light source is switched off, and the second one is operated (Step 6, FIG. 9).

The tuning range of the second source is scanned (Step 7, FIG. 9), so as to detect the maximum peak signal at the detector (Step 8, FIG. 9), at the second line 32′. It is known that the beam passes through line 32′ by causing the spot to scan the tuning range starting from the side of line 32′, so that the first signal detected corresponds to line 32′. This completes the tuning procedure.

The rotating element 5 and sources 7′ are then operated according to the imaging sequence.

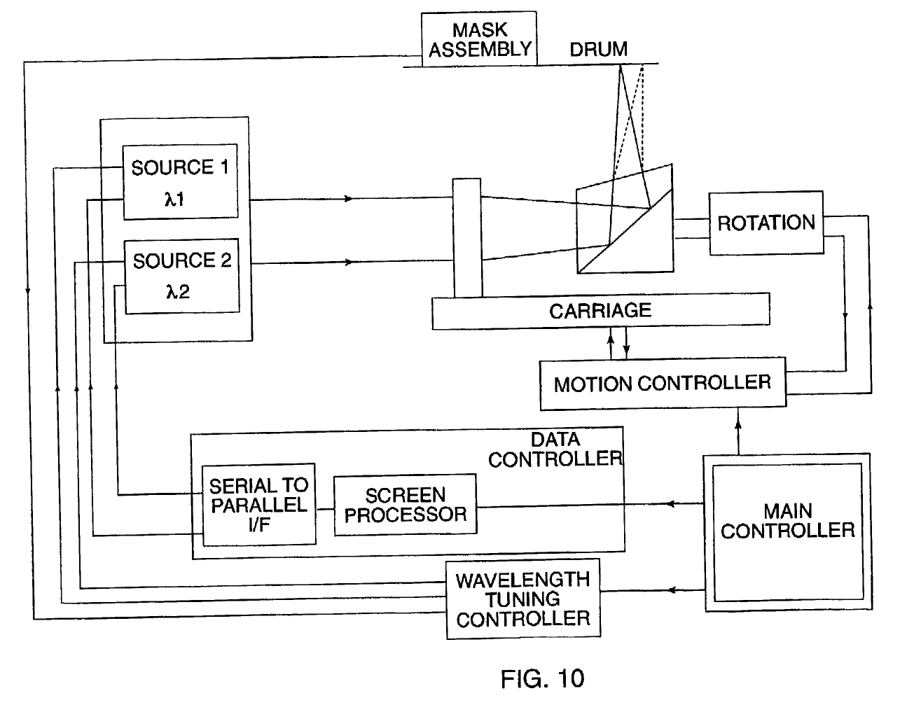

FIG. 10 schematically shows the operation of the system at the block diagram level. The main controller sets the wavelength of the sources according to the imaging resolution requirement. This is done through the wavelength tuning controller which tunes the wavelengths of source 1 and source 2, under monitoring of the mask assembly. Once this procedure is performed, the mechanical motions of the carriage and the rotating element are operated through the motion controller. In synchronization, the image data is sent to the data flow controller, which sends the exposing information to source 1 and source 2, through the screen processor and serial-to-parallel interface.

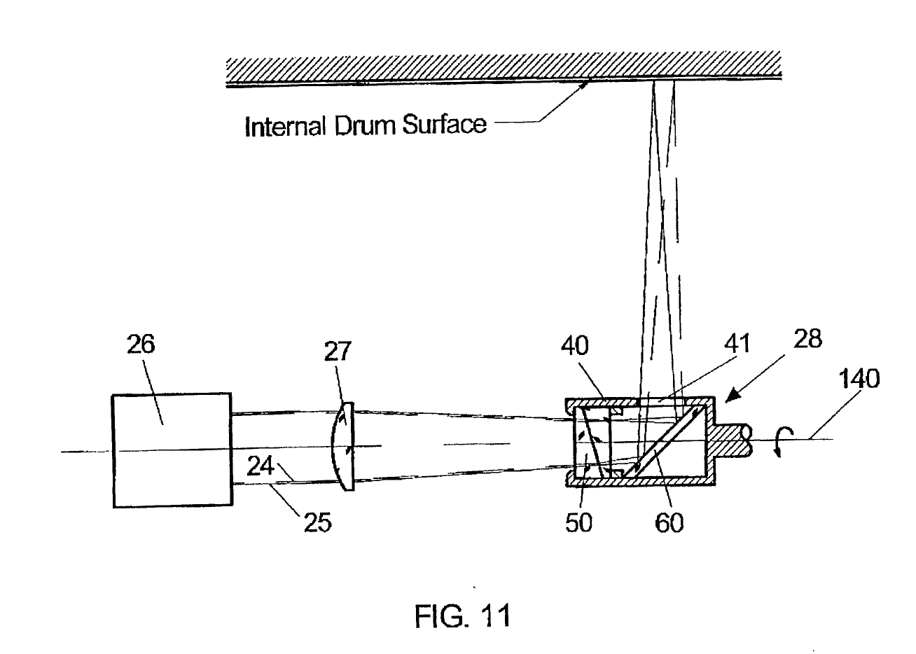

In another preferred embodiment (FIG. 11) of the present invention the reflective surface of the deflecting element 28 is separated from the dispersing element. The dispersing element 50, the performance of which will be addressed and the reflective element 60, are mounted in common holder 40 so as to rotate in synchrony. The reflective element 60 can be, as illustrated, a plane mirror mounted at angle of approximately 45° with respect to the axis of rotation 140 or other reflecting optical element such as roof prism or reflecting cube.

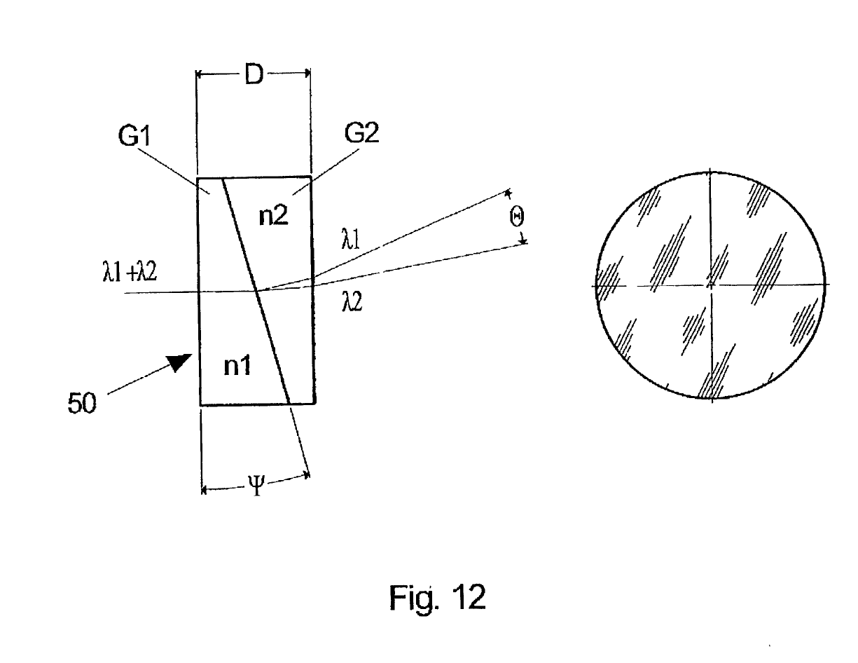

Referring to FIG. 12, the performance of the dispersing element 50 will be explained. The element consists of two optically cemented or optically contacted wedges G1 and G2 of optical glass or other optically transparent material. The dispersing element illustrated on FIG. 12 has parallel entrance and exit surfaces, but designs with slight inclinations are also possible, depending on the particular optical design. The index of refraction of G1 and G2 is respectively n1 and n2. A perfectly aligned beam consisting of two wavelengths λ1 and λ₂ experiences two refractions: first on the interface G1-G2 and then on the interface G2-air. Due to dispersion, two beams with wavelengths λ₁ and λ₂ respectively, emerge from the dispersing element. The angle θ between beams λ₁ and λ₂ (highly exaggerated on the figure) depends on the refractive indexes of G1 and G2, n₁(λ) and n₂(λ), respectively. For achieving high dispersion angle θ while keeping the optical aberrations as low as possible, it is preferable that the G1 and G2 are chosen so that

$${n}_{1} ( \frac{{λ}_{1} + {λ}_{2}}{2} ) \approx {n}_{2} ( \frac{{λ}_{1} + {λ}_{2}}{2} )$$

while the corresponding V-numbers (defined as

$$( \text{defined as} {V}_{i} = \frac{{n}_{i} ( \frac{{λ}_{1} + {λ}_{2}}{2} ) - 1}{{n}_{i} ( {λ}_{1} ) - {n}_{i} ( {λ}_{2} )} , i = 1 , 2 )$$

i=1,2) differ as much as possible. For example, if G1 and G2 are Schott's SF15 and LAK31 respectively, Ψ=27 arc deg, λ₁=645 nm and λ₂=655 nm then θ=0.18 mrad, which at 200 mm drum radius leads to 38 microns displacement. In the same time the OPD (Optical Path Difference) for 10 mm radius beam does not exceed λ/10 (perfect focusing lens 27, FIG. 11 considered).It is appreciated, that the dispersing element 50 can be with circular (as illustrated on FIG. 12) or other cross section, namely rectangular, square, etc., depending on the concrete design.

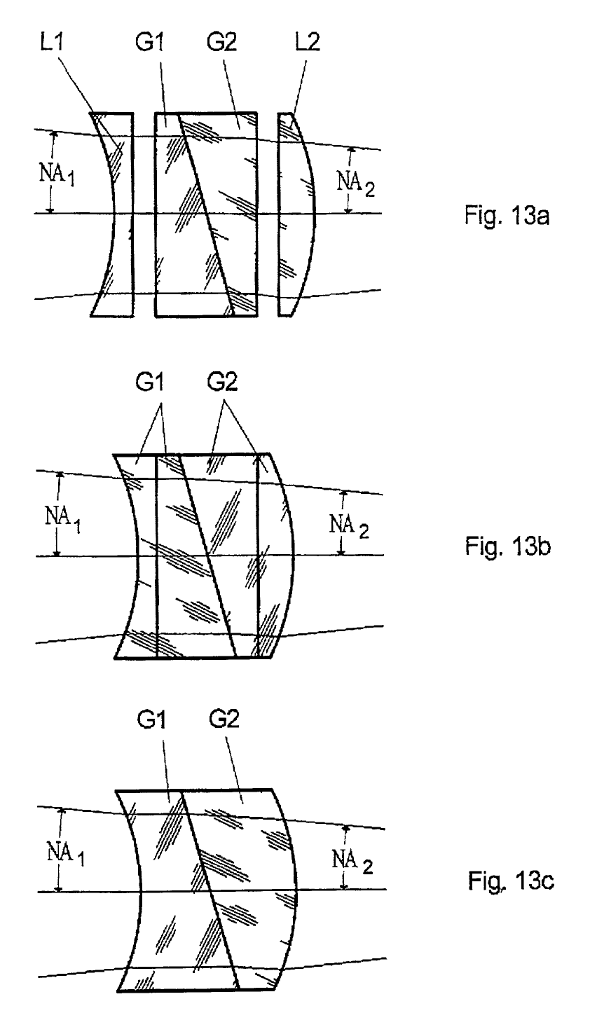

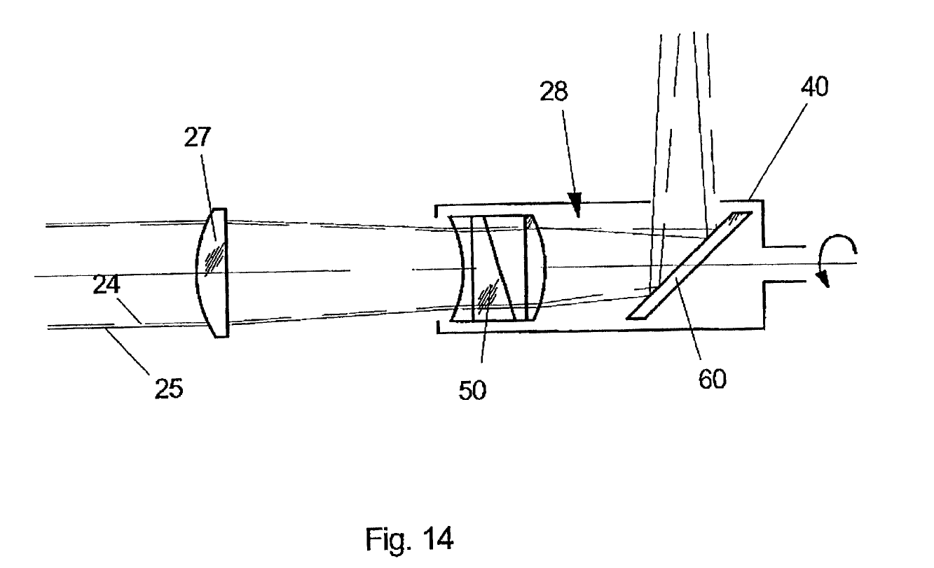

The main optical aberration in the system is astigmatism, resulting from the converging entrance beam. Therefore, further improvement of the OPD value can be achieved by adding two additional lenses L1 and L2 as shown on FIGS. 13a to 13c and FIG. 14. In the present invention lens L1 works as collimating lens that converts an entrance beam with numerical aperture NA₁ into substantially parallel beam. Thus the entrance and exit beams for the dispersing element are substantially parallel. Lens L2 converts the parallel beam emerging from the dispersing element into a converging beam with numerical aperture NA₂. In some particular cases NA₂ can be chosen to equal NA₁. Lenses L1 and L2 are static with regard to the dispersing element 50 and the reflecting element 60 and rotate synchronously with them (FIG. 14). This embodiment allows for using lens 27 as focusing lens in the same way as with the embodiment of FIG. 11, providing in the same way much better OPD value due to the parallel beam being dispersed by the dispersing element 50. If we now return to the example given above, the OPD value achieved is better than λ/20 and no significant astigmatism is presented. Lenses L1 and L2 can be made from same optical materials as G1 and G2 respectively, or from different ones, depending on the particular optical system. They can be separated from the dispersing element 50 (FIG. 13a), cemented to it (FIG. 13b), or even integrated (FIG. 13c).

The main advantages of the described deflective spinner are:

1. Low optical aberrations allowing for high resolution imaging

2. Lower weight compared to prism deflecting elements

3. Cylindrical symmetry and possibility for enclosing in aerodynamically shaped holder

4. The last two advantages allow for high speed rotating spinners and hence for high-speed printing.

While embodiments of the invention have been described by way of illustration, it will be understood that the invention can be carried out by persons skilled in the art with many modifications, variations and adaptations, without departing from its spirit or exceeding the scope of the claims.

1. A dispersing element for wavelength region {λ₁, λ₂}, comprising two optically contacted or optically cemented optically transparent wedges with approximately equal indexes of refraction for the central wavelength
$$\frac{{λ}_{1} + {λ}_{2}}{2} ,$$
and highly different V-numbers.

2. A dispersing element comprising the dispersing element of claim 1 and first and second lenses, said first lens being positioned before the dispersing element's entrance surface and substantially collimating an entrance beam, and said second lens being positioned after the dispersing element and substantially focusing an exit beam.

3. The dispersing element of claim 2, wherein said first and second lenses are optically cemented to the dispersing element of claim 1.

4. The dispersing element of claim 2, wherein said first and second lenses are integrated in the dispersing element of claim 1.

5. A deflective element for use in a multi-beam, multi-wavelength internal drum recording apparatus, comprising the dispersing element of claim 1 and a reflective element rotating in synchrony with said dispersing element, said reflective element's reflective surface being inclined at about 45 degrees with respect to an input beam.

6. A deflective element for use in a multi-beam, multi-wavelength internal drum recording apparatus, comprising the dispersing element of claim 2 and a reflective element rotating in synchrony with said dispersing element, said reflective element's reflective surface being inclined at about 45 degrees with respect to an input beam.

7. A deflective element for use in a multi-beam, multi-wavelength internal drum recording apparatus, comprising the dispersing element of claim 3 and a reflective element rotating in synchrony with said dispersing element, said reflective element's reflective surface being inclined at about 45 degrees with respect to an input beam.

8. A deflective element for use in a multi-beam, multi-wavelength internal drum recording apparatus, comprising the dispersing element of claim 4 and a reflective element rotating in synchrony with said dispersing element, said reflective element's reflective surface being inclined at about 45 degrees with respect to an input beam.

9. Internal drum recording apparatus provided with a rotating deflecting element, comprising two or more beams of different wavelenghts, said two or more beams being simultaneously operatable, and optical elements for bringing said two or more beams to a common optical path before they reach said rotating deflecting element.

10. Apparatus according to claim 9, wherein the deflecting element has dispersing properties such that beams of different wavelengths will leave it at slightly different angles.

11. Apparatus according to claim 9, wherein the beams of different wavelengths are generated by laser diodes.

12. Apparatus according to claim 11, wherein the laser diodes are tunable laser diodes.

13. Apparatus according to claim 9, comprising a beam combiner to combine the beams generated by the light sources.

14. Apparatus according to claim 13, wherein the beam combiner is a beam splitter.

15. Apparatus according to claim 13, wherein the beam combiner is a dichroic beam combiner.

16. Apparatus according to claim 13, wherein the beam combiner comprises an optical fiber coupler.

17. A dispersing prism for use as a deflecting element in a multi-beam, multi-wavelength internal drum recording apparatus, comprising two coupled transparent optical elements between which a reflective surface is provided, said reflective surface being inclined at about 45 degrees with respect to the input beam, and wherein the input and/or output face(s) of the prism are tilted with respect to the optical axis.

18. A dispersing prism for use as a deflecting element in a multi-beam, multi-wavelength internal drum recording apparatus, comprising two coupled transparent optical elements between which a reflective surface is provided, said reflective surface being inclined at about 45 degrees with respect to the input beam, and wherein the input or output face of the prism has a cylindrical shape.

19. A prism assembly comprising a prism according to claim 18, which is coupled to a lens having a refractive index different from that of the dispersing prism.

20. A prism assembly according to claim 19, wherein the lens is a cylindrical lens.

21. A prism assembly according to claim 19, wherein the lens is a wedge cylindrical lens.

22. A prism assembly comprising a prism according to claim 18 which is coupled to a wedged prism.

23. A method for separating the imaged lines in a multi-beam, multi-wavelength internal drum recording apparatus, by tuning the source wavelength, said method comprising the steps of providing, for each desired resolution, a mask consisting of a reflective layer deposited on a transparent surface from which said reflective layer has been removed so as to form two parallel line segments positioned one after the other with an offset, the width of said lines being small compared to the optical spot size used, positioning behind the mask a light detector capable of detecting peak signals, and tuning independently at least one of the light sources so as to obtain the maximum peak signal.

24. A method for operating with high throughput an internal drum recording apparatus provided with a rotating deflecting element, comprising providing two or more simultaneously operatable beams of different wavelenghts, and bringing said two or more beams to a common optical path before they reach said rotating deflecting element.

25. A method according to claim 23, wherein the deflecting element has dispersing properties such that beams of different wavelengths will leave it a slightly different angles.

26. Internal drum recording apparatus, essentially as described and illustrated and with particular reference to the drawings.
